(19) United States
(12) Patent Application Publication
(10) Pub. No.: US 2007/0230497 A1
(43) Pub. Date: Oct. 4, 2007

(54) Method and apparatus to negotiate channel sharing in PLC network

(75) Inventors: Jun-hae Choi, Seongnam-si (KR); Joon-hee Lee, Gunpo-si (KR); Ju-han Lee, Suwon-si (KR); Hyun-ah Sung, Seoul (KR); In-hwan Kim, Suwon-si (KR); Ho-Jeong You, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/705,454

(22) Filed: Feb. 13, 2007

(30) Foreign Application Priority Data
Mar. 31, 2006 (KR) 2006-29808
Jul. 20, 2006 (KR) 2006-67944

(51) Int. Cl. H04B 7/212

(52) U.S. Cl. 370/442

(57) ABSTRACT

A method of negotiating channel sharing between adjacent cells when there are a plurality of cells in a power line communication (PLC) network. The method includes attempting to negotiate the channel sharing during a minimum contention access period (CAP) which starts after a maximum beacon period ends and ends before a CAP of each PLC cell ends, wherein the maximum beacon period indicates a maximum size that a beacon frame in a super-frame transmitted from a coordinator of each PLC cell can have. When an attempt to negotiate the channel sharing is made using this method, interference does not occur during channel sharing negotiation, and effective channel sharing can be achieved, thereby eliminating interference between adjacent cells.

### CROSS-REFERENCE TO RELATED APPLICATIONS

This application claims priority under 35 U.S.C. § 119(a) of Korean Patent Application No. 10-2006-0029808, filed on Mar. 31, 2006, and Korean Patent Application No. 10-2006-0067944, filed on Jul. 20, 2006, in the Korean Intellectual Property Office, the disclosure of which is incorporated herein in its entirety by reference.

### BACKGROUND OF THE INVENTION

1. Field of the Invention

The present general inventive concept relates to a method and apparatus to negotiate channel sharing between adjacent cells when there are a plurality of cells in a power line communication (PLC) network.

2. Description of the Related Art

Recently there has been widespread adoption of digital consumer electronic technologies such as digital TV's, video recorders, and computers, resulting in an increased need for home networking technologies that enable seamless distribution of data and multimedia. Most homes are not equipped with specialized wiring for networking, and retrofitting them with new wiring is very expensive. Hence, there is a need for a wireless local area networking technology that enables affordable connectivity within the home. With multiple outlets in every room, powerlines are the most prevalent wires within the average home. The use of this wiring for networking purposes (i.e., power line communications) can provide a viable solution to the home networking problem (i.e., power line communication networking).

When there are a plurality of cells in a power line communication (PLC) network, it is impossible for respective coordinators of the cells to communicate with one another. However, stations in different cells may interfere with one another. If there are a large number of stations that interfere with one another, data throughput within each cell may be significantly reduced. Therefore, it may be advantageous for a cell to share a time division multiple access (TDMA) channel with an adjacent cell in order to reduce interference and increase data throughput. When adjacent cells are to share a TDMA channel, since respective coordinators of the adjacent cells cannot directly communicate with each other, the adjacent cells must negotiate channel allocation through a relay of respective stations within the adjacent cells. In other words, such a negotiation process is required when a cell desires to occupy a channel without being interfered with by a station of an adjacent cell.

FIG. 1 is a diagram illustrating interference between respective stations of adjacent PLC cells.

A coordinator forms a PLC cell, which is a logical PLC network. A station requests the coordinator to approve its participation in the PLC cell and, if the coordinator approves, the station participates in the PLC cell. The station identifies information (hereinafter, referred to as time allocation information) regarding time allocated to the station by a beacon transmitted from the coordinator. The station periodically transmits a station announcement (SA) in order to report information regarding the station and the PLC cell to which the station belongs. Basically, communication is possible only between stations within a cell. Therefore, the communication between station A1 (STA-A1) and station B1 (STA-B1) illustrated in FIG. 1 may serve as interference to both of them. However, station A1 (STA-A1) and station B1 (STA-B1) can receive each other's SAs.

Referring to FIG. 1, a coordinator A (Co.A) of a cell A and a coordinator B (Co.B) of a cell B cannot directly communicate with each other. However, since stations A1 (STA-A1) and B1 (STA-B1), which are respectively included in the cells A and B, can communicate with each other, they interfere with each other. In other words, when station A1 (STA-A1) of cell A attempts to communicate with another station within the cell A, a corresponding communication packet may also be delivered to station B1 (STA-B1), which may interfere with the communication of station B1 (STA-B1). The same is true the other way around. Hence, even if stations A1 (STA-A1) and B1 (STA-B1) do not intend to communicate with each other, contention free periods (CFPs) respectively allocated to stations A1 (STA-A1) and B1 (STA-B1) may be interfered with in a worst-case scenario.

As described above, by receiving each other's SAs, each of the stations A1 (STA-A1) and B1 (STA-B1) may perceive the fact that station A1 (STA-A1), for example, in the cell A which is different from the cell B to which station B1 (STA-B1) belongs, transmits its SA to station B1 (STA-B1), which causes interference to B1 (STA-B1). Hence, B1 (STA-B1) needs to notify coordinator B (Co.B) of its cell about this interference in order to effectively set channel sharing and thus avoid collisions in communication with an adjacent cell. In this case, stations A1 (STA-A1) and B1 (STA-B1) relay a negotiation process between respective coordinators A (Co.A) and B (Co.B) of the different cells A and B to which stations A1 (STA-A1) and B1 (STA-B1) respectively belong. Stations A1 (STA-A1) and B1 (STA-B1) receive beacons containing time allocation information from respective coordinators A (Co.A) and B (Co.B) of the cells A and B, respectively. Due to different scheduling, a message transmitted by station A1 (STA-A1) or B1 (STA-B1) for negotiation may also interfere with station B1 (STA-B1) or A1 (STA-A1).

FIG. 2 illustrates a super-frame structure of each PLC cell. Since different times are allocated to a cell A and a cell B in their respective super-frames, it is not easy to set a time when stations A1 (STA-A1) and B1 (STA-B1) may attempt to negotiate. For example, if station A1 (STA-A1) attempts to negotiate with station B1 (STA-B1) at a time indicated by an arrow ↓ in FIG. 2, the negotiation attempt of station A1 (STA-A1) is made during a beacon period or a contention free period of station B1. Consequently, this negotiation process interferes with station B1.

If the negotiation attempt of station A1 (STA-A1) is made during a contention access period (CAP) of station B1 (STA-B1), the negotiation attempt itself may not serve as interference to station B1 (STA-B1). However, if the negotiation attempt of station A1 (STA-A1) is made during the beacon period or CFP of station B1 (STA-B1), the negotiation attempt itself may serve as interference to station B1 (STA-B1).

### SUMMARY OF THE INVENTION

The present general inventive concept provides a method of negotiating channel sharing between adjacent cells, which interfere with each other, in a power line communication (PLC) network in order to allow the adjacent cells to effectively share a channel through a negotiation process and to prevent the negotiation process itself from interfering with an adjacent cell. Since the adjacent cells can effectively share a channel using the method, interference between the adjacent cells can be eliminated, and communication performance can be enhanced.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a method of negotiating time division multiple access (TDMA) channel sharing in a PLC network, the method including attempting to negotiate channel sharing during a minimum contention access period (CAP) which starts after a maximum beacon period ends and ends before a CAP of each PLC cell ends, wherein the maximum beacon period indicates a maximum size that a beacon frame in a super-frame transmitted from a coordinator of each PLC cell can have.

Each station attempting to negotiate channel sharing may register a target station for negotiation with a detected station table or a detected cell table.

Each station attempting to negotiate channel sharing may add a predetermined flag to a command frame that is to be transmitted to the target station, wherein the predetermined flag indicates that the command frame is for channel sharing negotiation.

The foregoing and/or other aspects of the present general inventive concept may also be achieved by providing a computer-readable recording medium having embodied thereon a computer program to execute a method of negotiating time division multiple access (TDMA) channel sharing in a power line communication (PLC) network, the method including attempting to negotiate channel sharing during a minimum contention access period (CAP) which starts after a maximum beacon period ends and ends before a CAP of each PLC cell ends, wherein the maximum beacon period indicates a maximum size that a beacon frame in a super-frame transmitted from a coordinator of each PLC cell can have.

The foregoing and/or other aspects of the present general inventive concept may also be achieved by providing a method of negotiating TDMA channel sharing in a PLC network, the method including perceiving interference of a second station included in a second cell and notifying a first coordinator of a first cell about the interference using a first station included in the first cell, transmitting a shared channel request to the second station through a minimum CAP and using the first station, and transmitting the shared channel request to the second coordinator of the second cell using the second station, transmitting to the first station first scheduling information of the second cell, which is received from the second coordinator through the second station, and transmitting the first scheduling information of the second cell to the first coordinator using the first station, transmitting to the second station second scheduling information of the first cell received from the first coordinator through the first station, and transmitting the second scheduling information of the first cell to the second coordinator using the second station, and broadcasting time allocation information for channel sharing to each station included in each of the first and second cells using the first coordinator and the second coordinator, wherein the minimum CAP starts after a maximum beacon period ends and ends before a CAP of each PLC cell ends.

The first station may register the second station as a target station with a detected station table (DST) or a detected cell table (DCT). In addition, the second station may register the first station as a target station with a DST or a DCT.

The first station may add a predetermined flag to a command frame that is to be transmitted to the second station, and the predetermined flag indicates that the command frame is for channel sharing negotiation. In addition, the second station may add a predetermined flag to a command frame that is to be transmitted to the first station, and the predetermined flag indicates that the command frame is for channel sharing negotiation.

The foregoing and/or other aspects of the present general inventive concept may also be achieved by providing a computer-readable recording medium having embodied thereon a computer program to execute a method of negotiating TDMA channel sharing in a PLC network, the method including perceiving interference of a second station included in a second cell and notifying a first coordinator of a first cell about the interference using a first station included in the first cell, transmitting a shared channel request to the second station through a minimum CAP and using the first station, and transmitting the shared channel request to the second coordinator of the second cell using the second station, transmitting to the first station first scheduling information of the second cell, which is received from the second coordinator through the second station, and transmitting the first scheduling information of the second cell to the first coordinator using the first station, transmitting to the second station second scheduling information of the first cell received from the first coordinator through_the first station, and transmitting the second scheduling information of the first cell to the second coordinator using the second station, and broadcasting time allocation information for channel sharing to each station included in each of the first and second cells using the first coordinator and the second coordinator, wherein the minimum CAP starts after a maximum beacon period ends and ends before a CAP of each PLC cell.

The foregoing and/or other aspects of the present general inventive concept may also be achieved by providing a station negotiating TDMA channel sharing in a PLC network including an interference perception unit to perceive interference of a station included in another cell, a transmission unit transmitting a command frame to a coordinator or another station, a reception unit to receive another command frame from the coordinator or the other station, and a frame generation unit to generate the command frame that is to be transmitted to the coordinator or the another station, wherein the command frame and the another command frame negotiate TDMA channel sharing and are received or transmitted during a minimum CAP, and the minimum CAP starts after a maximum beacon period ends and ends before a CAP of each PLC cell ends.

The frame generation unit may add a predetermined flag to the command frame to indicate that the command frame is for channel sharing negotiation.

The station may further include a table registering a station or cell which is a target station for channel sharing negotiation.

The table may be a DST or a DCT.

The foregoing and/or other aspects of the present general inventive concept may also be achieved by providing a coordinator negotiating TDMA channel sharing in a PLC network including a transmission unit to transmit a command frame to a station; a reception unit to receive another command frame from the station, and a frame generation unit to generate the command frame that is to be transmitted to the station, wherein the command frame and the another command frame negotiate TDMA channel sharing and are received or transmitted during a minimum CAP, wherein the minimum CAP starts after a maximum beacon period ends and ends before a CAP of each PLC cell ends.

The frame generation unit may add a predetermined flag to the command frame to indicate that the command frame is for channel sharing negotiation.

The foregoing and/or other aspects of the present general inventive concept may also be achieved by providing a station of a cell in a power line communication (PLC) network, the station including a transmission unit to transmit a command frame to a coordinator or another station of another cell in the PLC network, a reception unit to perceive interference of the another station included in the another cell and to receive another command frame from the coordinator or the another station of the another cell, and a frame generation unit to generate the command frame that is to be transmitted to the coordinator or the another station of the another cell, wherein the command frame and the another command frame negotiate channel sharing and contain a membership key that must not be ignored or abandoned by the coordinator or the another station of the another cell, the command frame being received or transmitted during a minimum contention access period (CAP).

The foregoing and/or other aspects of the present general inventive concept may also be achieved by providing a computer-readable recording medium on which a program for executing the method of negotiating TDMA channel sharing in the PLC network is recorded.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a diagram illustrating interference between respective stations of adjacent power line communication (PLC) cells A and B;

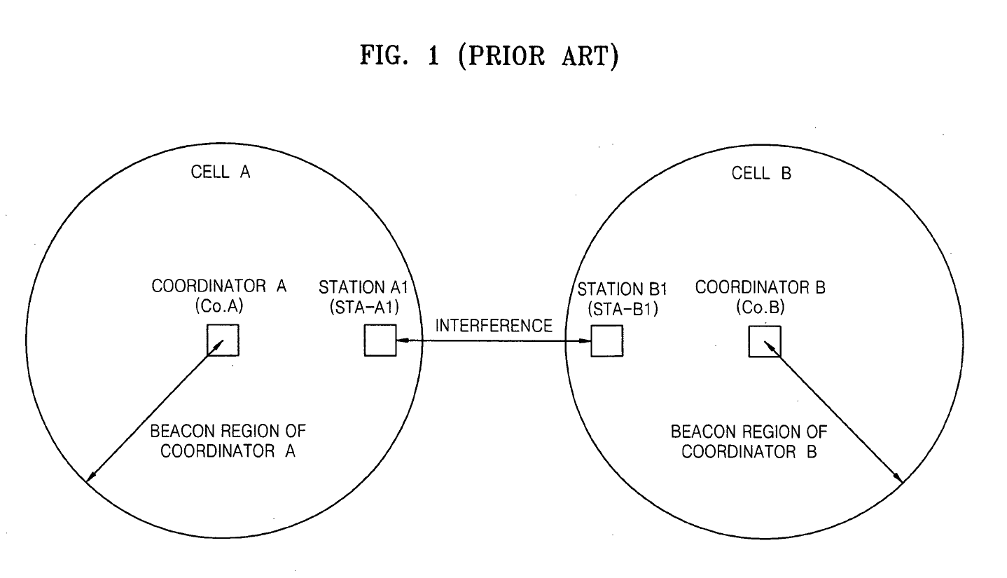

FIG. 2 illustrates a super-frame structure of each of the PLC cells A and B of FIG. 1;

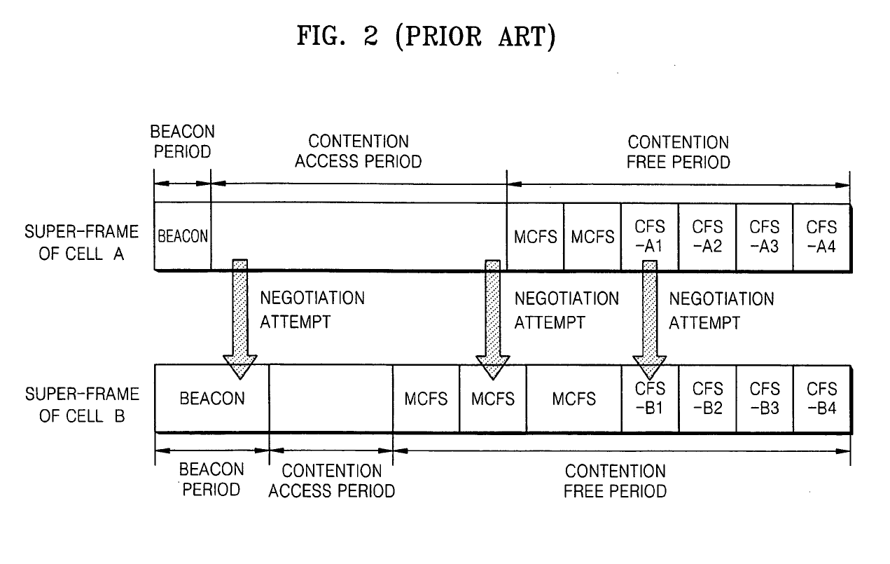

FIG. 3 illustrates a super-frame structure in a PLC network according to an embodiment of the present general inventive concept;

FIG. 4 illustrates a process of negotiating channel sharing in order to eliminate the interference of an adjacent cell according to an embodiment of the present general inventive concept; and

FIG. 5A is a schematic block diagram of a station performing TDMA channel sharing negotiation in a PLC network, and FIG. 5B is a schematic block diagram of a coordinator performing TDMA channel sharing negotiation in the PLC network.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

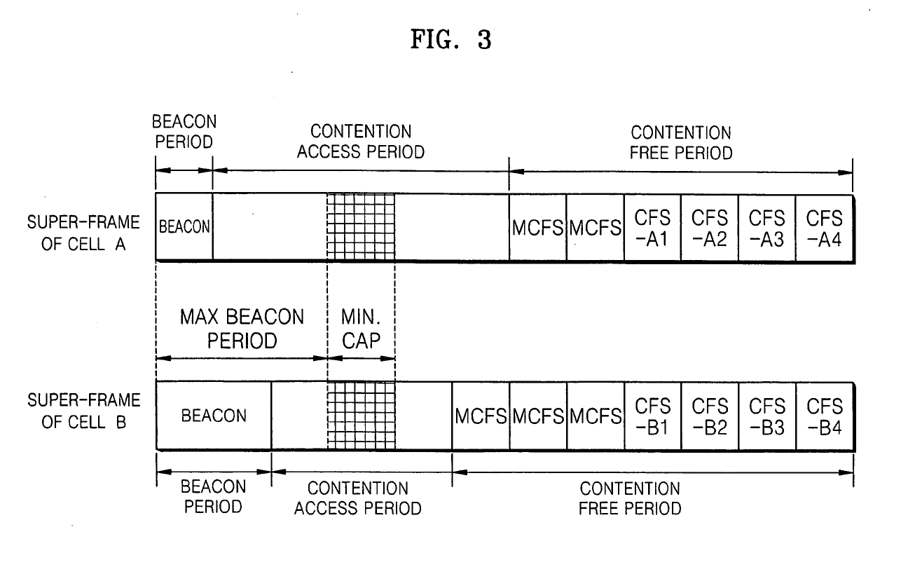

FIG. 3 illustrates a super-frame structure in a power line communication (PLC) network according to an embodiment of the present general inventive concept. FIG. 3 also illustrates the beacon period, a contention access period (CAP), and a contention free period (CFP) of the super-frame structure of cells A and B. The CAP uses a carrier sense multiple access (CSMA) method, and the CFP uses a time division multiple access (TDMA) method. Time information of the CAP and the CFP is included in a beacon and is transmitted during the beacon period.

In the present embodiment, a maximum beacon period, which is a virtual period, and a minimum CAP are newly defined, and all cells in a PLC network have equal maximum beacon periods and minimum CAPs. The maximum beacon period indicates a maximum size that a beacon frame can have, and the minimum CAP indicates a minimum CAP guaranteed by a coordinator of a cell in the network. The length of cell super frames in the present embodiment is equal to a multiple of an alternating current (AC) line cycle. Specifically, the maximum beacon period indicates a maximum size value that a beacon frame of each cell can have, and the maximum size value may be a fixed value. The minimum CAP starts after the maximum beacon period ends and ends before the CAP of each cell ends. Therefore, the minimum CAP is included in the CAP of each cell. The minimum CAP may be a fixed or variable value. The negotiation for channel sharing between cells that interfere with each other is performed using the minimum CAP. The CFP may include mandatory contention free slots (MCFS) and contention free slots (CFS-A1, CFS-A2, CFS-A3, and CFS-A4). The CFP may have a fixed or variable period.

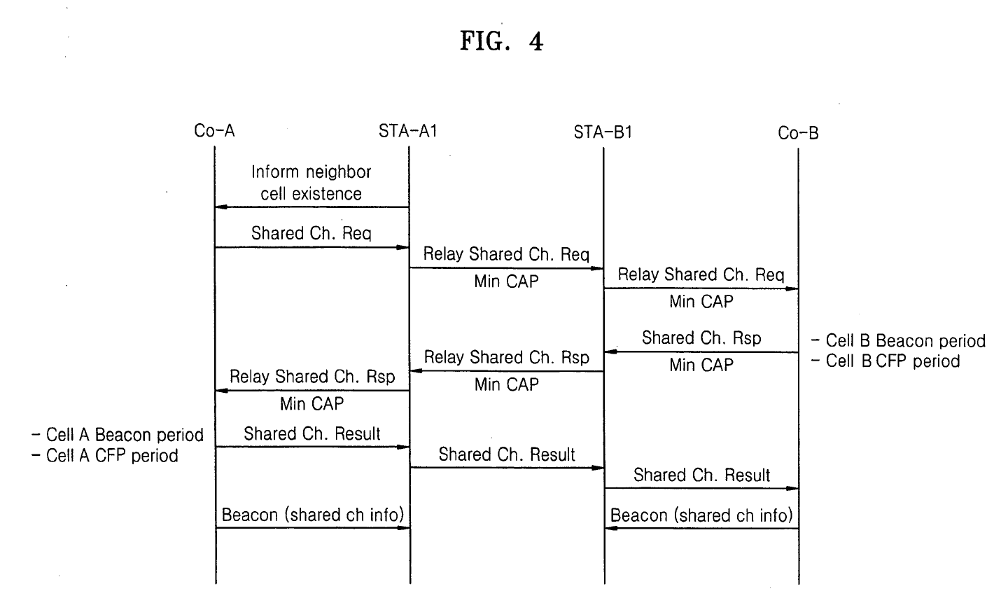

FIG. 4 illustrates a process in which station A1 (STA-A1), which perceives interference of station B1 (STA-B1), negotiates channel sharing with station B1 (STA-B1) in order to eliminate the interference of station B1 (STA-B1) according to an embodiment of the present general inventive concept. It is assumed that stations A1 (STA-A1) and B1 (STA-B1) are included in adjacent cells that can interfere with each other. To negotiate channel sharing, station A1 (STA-A1) and station B1 (STA-B1) exchange command frames for negotiation during the minimum CAP which starts after the maximum beacon period ends and ends before the CAP of each cell ends. The minimum CAP may correspond to a checkered region illustrated in FIG. 3.

The negotiation process illustrated in FIG. 4 will now be described. Station A1 (STA-A1) perceives the interference of station B1 (STA-B1) and notifies a coordinator A (Co-A) of cell A, to which station A1 (STA-A1) belongs, about the interference. If channel sharing is needed, coordinator A (Co-A) transmits a shared channel request to station A1 (STA-A1) so that station A1 (STA-A1) can try for channel sharing with cell B, which is adjacent to cell A. Station A1 (STA-A1) receives the shared channel request and transmits the shared channel request to station B1 (STA-B1) through a region that would least interfere with station B1 (STA-B1), i.e., the checkered region (minimum CAP) illustrated in FIG. 3. Station B1 (STA-B1) receives the shared channel request and transmits the shared channel request to coordinator B (Co-B) through the minimum CAP. Then, coordinator B (Co-B) transmits to station B1 (STA-B1) a shared channel response containing a beacon period, which is scheduling information of cell B, and information regarding cell B's contention free period (CFP), during the minimum CAP. Station B1 (STA-B1) receives the shared channel response and relays the shared channel response to station A1 (STA-A1) through a region that would cause the least interference with station A1 (STA-A1), i.e., the checkered region (minimum CAP) illustrated in FIG. 3. Station A1 (STA-A1) receives the shared channel response and transmits the shared channel response to the coordinator A (Co-A) through the minimum CAP.

Coordinator A (Co-A) receives the shared channel response and transmits to station A1 (STA-A1) a result message containing first information regarding a beacon period and a CFP, which can be used by cell A, and second information regarding a beacon period and a CFP, which can be used by cell B. Station A1 (STA-A1), which receives the result message, transmits the result message to station B1 (STA-B1) through a region that would least interfere with station B1 (STA-B1), i.e., the checkered region (minimum CAP) illustrated in FIG. 3. Station B1 (STA-B1) receives the result message and transmits the result message to coordinator B (Co-B) during the minimum CAP.

If this negotiation process is successfully completed, coordinators A (Co-A) and B (Co-B) include time allocation information for channel sharing in respective beacons and broadcast the beacons to each station included in cells A and B. Then, all stations which receive the beacons, in particular, stations A1 (STA-A1) and B1 (STA-B1), can more effectively communicate with other stations without interference from other stations or coordinators in adjacent cells.

In the negotiation process illustrated in FIG. 4, each of station A1 (STA-A1) and station B1 (STA-B1) in different PLC cells is required not to ignore or abandon a command frame even if a membership key of the command frame is different. Since stations A1 (STA-A1) and B1 (STA-B1) belong to different PLC cells, they transmit command frames including different membership keys. In ordinary cases, there is no need for stations in different PLC cells to exchange command frames. If a station receives a command frame including a membership key of another PLC cell, the station may ignore or abandon the command frame. However, a command frame received for a TDMA channel sharing negotiation process must not be ignored or abandoned even if the command frame includes a membership key of another PLC cell. If the command frame for the TDMA channel sharing negotiation process is ignored or abandoned, the channel sharing negotiation cannot proceed. Therefore, a method of recognizing a command frame having a membership key that must not be ignored or abandoned is required.

In a method of recognizing a command frame having a membership key that must not be ignored or abandoned, a station registers necessary information with a detected station table (DST) and a detected cell table (DCT) using a station announcement (SA) that was received previously. For example, it is assumed that stations A1 (STA-A1) and B1 (STA-B1) are included in different PLC cells. In this case, station A1 (STA-A1) receives an SA including information regarding channel sharing negotiation from station B1 (STA-B1). Then, station A1 (STA-A1) registers information regarding station B1 (STA-B1) or the PLC cell to which station B1 (STA-B1) belongs with the DST and DCT based on the previously received SA. Later, if station A1 (STA-A1) receives command frame related to the channel sharing negotiation from station B1 (STA-B1), station A1 (STA-A1) recognizes the command frame as a command frame having a membership key that must not be ignored or abandoned based on the information registered with the DST and DCT.

In another method of recognizing a command frame having a membership key that must not be ignored or abandoned, a predetermined flag is added to a command frame. The command frame including the flag must not be ignored or abandoned although the command frame has a membership key of another cell. For example, when station A1 (STA-A1) receives the command frame related to the channel sharing negotiation from station B1 (STA-B1), if the received command frame includes the predetermined flag as described above, station A1 (STA-A1) performs the channel sharing negotiation without ignoring or abandoning the command frame which includes the membership key of another cell.

A station which desires to participate in a PLC cell can transmit a participation request to a coordinator or a station of the PLC cell, or receive a response to the participation request during the minimum CAP defined above, thereby preventing interference with other stations. In addition, a station in a PLC cell and a station in another PLC cell can exchange data or messages during the minimum CAP defined above, thereby preventing interference with other stations.

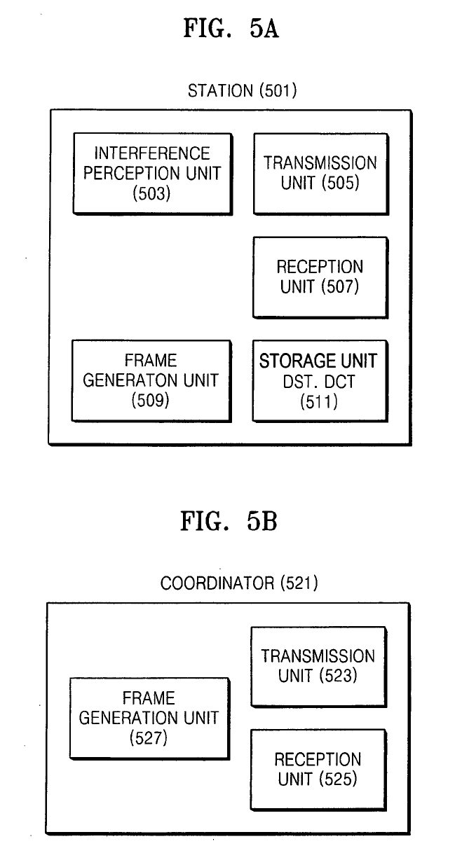

FIG. 5A is a schematic block diagram of a station 501 performing TDMA channel sharing negotiation in a PLC network according to an embodiment of the present general inventive concept. The station 501 transmits or receives a command frame for the TDMA channel sharing negotiation during a minimum CAP. In this case, the minimum CAP indicates a period which starts after a maximum beacon period ends and ends before a CAP of each PLC cell ends. The maximum beacon period indicates a maximum size that a beacon frame in a super-frame transmitted from a coordinator of each PLC cell can have.

The station 501 includes an interference perception unit 503 to perceive the interference of a station in a different cell, a transmission unit 505 to transmit the command frame to a coordinator or another station, a reception unit 507 to receive the command frame from the coordinator or the another station, a frame generation unit 509 to generate the command frame that is to be transmitted to the coordinator or the another station, and a table storage unit 511 to store a table that registers a station or cell, which is a target for the channel sharing negotiation.

In FIG. 5A, the interference perception unit 503 is illustrated as a separate element. However, the reception unit 507 may perceive the command frame transmitted from another PLC cell and determine interference. The frame generation unit 509 adds the predetermined flag to a generated command frame in order to indicate that the generated command frame is for the channel sharing negotiation. The table storage unit 511 may store a DST or DCT. When an interference station is detected, the DST includes information regarding the interference station and the DCT includes information regarding a cell to which the interference station belongs.

FIG. 5B is a schematic block diagram of a coordinator 521 to perform TDMA channel sharing negotiation in a PLC network according to an embodiment of the present general inventive concept. The coordinator 521 transmits or receives a command frame for the TDMA channel sharing negotiation during a minimum CAP. In this case, the minimum CAP indicates a period which starts after a maximum beacon period ends and ends' before a CAP of each PLC cell ends. The maximum beacon period indicates a maximum size that a beacon frame in a super-frame transmitted from a coordinator of each PLC cell can have.

The coordinator 521 includes a transmission unit 523 to transmit the command frame to a station, a reception unit 525 to receive the command frame from the station, and a frame generation unit 527 to generate the command frame that is to be transmitted to the station. The frame generation unit 527 adds a predetermined flag to the generated command frame in order to indicate that the generated command frame is for the channel sharing negotiation.

According to the present general inventive concept, an attempt for channel sharing negotiation is made during a minimum CAP which starts after a maximum beacon period ends and ends before a CAP of each cell ends. Therefore, interference does not occur during the channel sharing negotiation, and effective channel sharing can be achieved, thereby eliminating interference between adjacent cells.

The present general inventive concept can also be embodied as computer-readable codes on a computer-readable recording medium. The computer-readable recording medium is any data storage device that can store data which can be thereafter read by a computer system. Examples of the computer-readable recording media include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains. The method illustrated in FIG. 4 can be stored in the computer-recorded medium in a form of computer-readable codes to perform the method when the computer reads the computer-readable codes of the recording medium.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of negotiating time division multiple access (TDMA) channel sharing in a power line communication (PLC) network, the method comprising:
attempting to negotiate channel sharing during a minimum contention access period (CAP) which starts after a maximum beacon period ends and ends before a CAP of each PLC cell ends,
wherein the maximum beacon period indicates a maximum size that a beacon frame in a super-frame transmitted from a coordinator of each PLC cell can have.

2. The method of claim 1, wherein:
the attempting of the negotiation of the channel sharing comprises registering each station attempting to negotiate channel sharing as a target station for the negotiation with a detected station table or a detected cell table.

3. The method of claim 1, wherein:
the attempting of the negotiation of the channel sharing comprises registering each station attempting to negotiate the channel sharing, adding in a predetermined flag to a command frame that is to be transmitted to a target station; and
the predetermined flag indicates that the command frame is for channel sharing negotiation.

4. A computer-readable recording medium having embodied thereon a computer program to execute a method of negotiating time division multiple access (TDMA) channel sharing in a power line communication (PLC) network, the method comprising:
attempting to negotiate channel sharing during a minimum contention access period (CAP) which starts after a maximum beacon period ends and ends before a CAP of each PLC cell ends,
wherein the maximum beacon period indicates a maximum size that a beacon frame in a super-frame transmitted from a coordinator of each PLC cell can have.

5. A method of negotiating TDMA channel sharing in a PLC network, the method comprising:
perceiving interference of a second station included in a second cell and notifying a first coordinator of a first cell about the interference using a first station included in the first cell;
transmitting a shared channel request to the second station through a minimum CAP and using the first station, and transmitting the shared channel request to the second coordinator of the second cell using the second station;
transmitting to the first station first scheduling information of the second cell, which is received from the second coordinator through the second station, and transmitting the first scheduling information of the second cell to the first coordinator using the first station;
transmitting to the second station second scheduling information of the first cell received from the first coordinator through the first station, and transmitting the second scheduling information of the first cell to the second coordinator using the second station; and
broadcasting time allocation information for channel sharing to each station included in each of the first and second cells using the first coordinator and the second coordinator,
wherein the minimum CAP starts after a maximum beacon period ends and ends before a CAP of each PLC cell ends.

6. The method of claim 5, wherein the first station registers the second station as a target station, with a detected station table (DST) or a detected cell table (DCT).

7. The method of claim 5, wherein the second station registers the first station as a target station, with a DST or a DCT.

8. The method of claim 5, wherein
the first station adds a predetermined flag to a command frame that is to be transmitted to the second station; and
the predetermined flag indicates that the command frame is for channel sharing negotiation.

9. The method of claim 5, wherein:
the second station adds a predetermined flag to a command frame that is to be transmitted to the first station; and
wherein the predetermined flag indicates that the command frame is for channel sharing negotiation.

10. A computer-readable recording medium having embodied thereon a computer program to execute a method of negotiating TDMA channel sharing in a PLC network, the method comprising:
perceiving interference of a second station included in a second cell and notifying a first coordinator of a first cell about the interference using a first station included in the first cell;
transmitting a shared channel request to the second station through a minimum CAP and using the first station, and transmitting the shared channel request to the second coordinator of the second cell using the second station;
transmitting to the first station first scheduling information of the second cell, which is received from the second coordinator through the second station, and transmitting the first scheduling information of the second cell to the first coordinator using the first station;
transmitting to the second station second scheduling information of the first cell received from the first coordinator through_the first station, and transmitting the scheduling information of the first cell to the second coordinator using the second station; and
broadcasting time allocation information for channel sharing to each station included in each of the first and second cells using the first coordinator and the second coordinator,
wherein the minimum CAP starts after a maximum beacon period ends and ends before a CAP of each PLC cell ends.

11. A station to negotiate TDMA channel sharing in a PLC network, the station comprising:
an interference perception unit to perceive interference of a station included in another cell;
a transmission unit to transmit a command frame to a coordinator or another station;
a reception unit to receive another command frame from the coordinator or the another station; and
a frame generation unit to generate the command frame that is to be transmitted to the coordinator or the another station,
wherein the command frame and the another command frame negotiate TDMA channel sharing are received or transmitted during a minimum CAP, and the minimum CAP starts after a maximum beacon period ends and ends before a CAP of each PLC cell ends.

12. The station of claim 11, wherein the frame generation unit adds a predetermined flag to the command frame to indicate that the command frame is for channel sharing negotiation.

13. The station of claim 11, further comprising:
a table to register a station or cell which is a target station for channel sharing negotiation.

14. The station of claim 13, wherein the table is a DST or a DCT.

15. A coordinator to negotiate TDMA channel sharing in a PLC network, the coordinator comprising:
a transmission unit to transmit a command frame to a station;
a reception unit to receive another command frame from the station; and
a frame generation unit to generate the command frame that is to be transmitted to the station,
wherein the command frame and the another command frame negotiate TDMA channel sharing and are received or transmitted during a minimum CAP, wherein the minimum CAP starts after a maximum beacon period ends and ends before a CAP of each PLC cell ends.

16. The coordinator of claim 15, wherein the frame generation unit adds a predetermined flag to the command frame to indicate that the command frame is for channel sharing negotiation.

17. A station of a cell in a power line communication (PLC) network, the station comprising:
a transmission unit to transmit a command frame to a coordinator or another station of another cell in the PLC network;
a reception unit to perceive interference of the another station included in the another cell and to receive another command frame from the coordinator or the another station of the another cell; and
a frame generation unit to generate the command frame that is to be transmitted to the coordinator or the another station of the another cell,
wherein the command frame and the another command frame negotiate channel sharing and contain a membership key that must not be ignored or abandoned by the coordinator or the another station of the another cell, the command frame being received or transmitted during a minimum contention access period (CAP).
